(19) United States
(12) Patent Application Publication
(10) Pub. No.: US 2008/0294451 A1
(43) Pub. Date: Nov. 27, 2008

(54) INTERNET CONNECTION SERVICE PROVIDING METHOD AND SYSTEM

(75) Inventors: Hidehiko FUJIWARA, Kanagawa (JP); Yoshikazu KOBAYASHI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC INFRONTIA CORPORATION, Kanagawa (JP)

(21) Appl. No.: 12/060,654

(22) Filed: Apr. 1, 2008

Related U.S. Application Data
(62) Division of application No. 10/671,463, filed on Sep. 29, 2003.

(30) Foreign Application Priority Data
Nov. 11, 2002 (JP) 326657/2002

(51) Int. Cl. G06Q 99/00

(52) U.S. Cl. 705/1

(57) ABSTRACT

An internet connection service providing method and internet connection service system for carrying out the method are provided. The method comprises presetting a service class for a user, among a plurality of service classes, where the service class is selected by the user, authenticating the user according to the preset service class when the user logs-in to a network, recognizing the preset service class for the user, and providing a service corresponding to the recognized service class.

### BACKGROUND OF THE INVENTION

This application claims benefit of Japanese Patent Application No. 2002-326657 filed on Nov. 11, 2002, the contents of which are incorporated by the reference.

The present invention relates to an internet connection service providing method, i.e., a method of providing, for instance, an internet connection service in a public place (hereinafter referred to as “public internet connection service”), and a system applicable for carrying out the same method.

Recently, there has been a trend of providing for actual use of so-called “hot spot service”, in which internet connection and contents services are provided in such particular places in such locations as internet coffee shops, airports, hotels, coffee shops and fast food shops. Specifically, there has been a trend of providing, as service for a very limited area, a service of internet connection or the like by a wireless technique called local wireless interface such as wireless LAN and Bluetooth.

However, in case when a usual customer seeks to make connection to an access point of ISP (Internet Service Provider) by utilizing a public line or the like in his or her visited place, it is necessary to subscribe to the ISP beforehand. Otherwise, the service can not be utilized. In order to cope with this circumstance, a technique has been provided, which permits easy receiving the charge-free or inexpensive internet connection service and even outside his or her own home, although cost and man-hours are required for utilizing the service (see Literature 1, for instance, Japanese Patent Laid-open 2001-266018).

In another technique having been provided, a provider presets two or more courses with different internet connection fees per unit time and line qualities, and two or more IDs of different courses are allotted to one user for utilization, thus permitting the user to select a utilization form with a single contract according to the circumstance at the time of the connection (see Literature 2, for instance, Japanese Patent Laid-open 2002-32279).

In the meantime, the applicant has earlier proposed a fee charging method concerning the internet connection service, in which whenever making connection from a user terminal to the internet, the user freely selects and designates service conditions of a desired network service for utilization, and the network service use fee is collected based on the service class corresponding to the service conditions and the extent of communication utilized by the user (see Literature 3, for instance, Japanese Patent Laid-open 2001-298484).

Furthermore, in such case as when many subscribers commonly utilize an access point of ISP (internet service provider), a network connecting the access point to the subscribers is commonly used by the subscribers. Therefore, if a subscriber is down-loading a large quantity of files, it causes serious adverse effects of greatly reducing the throughput of the other users, thus making it impossible to ensure impartial service provision to the users. In order to cope with such problem, an internet access managing system has been proposed, in which ISP independently discriminates subscribers based on network connection data peculiar to the users and permits adequate traffic control and network connection status monitoring based on the subscriber's contact contents (see Literature 4, or instance, Japanese Patent Laid-open 2001-285353).

Still further, there has been proposed an advertisement system comprising a computer capable of being connected to internet or like communication network, an advertisement file with advertisements stored therein, a user data file with relevant-to-user data stored therein. In the system, the computer reads out, from the advertisement file, an advertisement concerning an advertisement distribution request inputted via the communication network, and outputs this advertisement together with added communication discrimination data of the user who has made the request, while privileges provided to the user are recorded in the user data file based on the advertisement distribution history and distribution history of request user. Thus, with various privileges such as a communication fee discount provided when advertisement distribution is received, users become observers of much advertisements, thus leading to improvement of the advertisement effect. (see Literature 5, for instance, Japanese Patent Laid-open 2002-170027).

As the prior art public internet connection service, only across-the-board or uniform services are provided irrespective of services requested by users, and the users have to pay across-the-board fee. To provide service versatility, a system, in which whenever utilizing a desired service the user can select the form of service with a single contact, has been proposed as described above. However, in some cases this system may lead to too cumbersome operation and decision.

### SUMMARY OF THE INVENTION

The present invention has been made in view of the above problems, and it has an object of providing an internet connection service providing method capable of providing versatility enhancement to the prior art service, a user's right of selection, permitting dealers to expand users with the provision of service versatility enhancement and being free from excessively cumbersome operation and decision, and also a system for carrying out the same method.

According to an aspect of the present invention, there is provided an internet connection service providing method, wherein service classes each for each user as a subject of authentication of log-in in network are preset, a service class preset for a logged-in user is recognized, and a service corresponding to a recognized service class to a pertinent user based on the recognition is provided.

A fee corresponding to the service class is computed based on fee managing data and charged to the pertinent user. An applicable service class is preset for each user on the basis of a contract.

According to another aspect of the present invention, there is provided an internet connection service providing method, wherein a particular ISP (internet service provider) provides an internet connection service in a plurality of places, and user management data concerning service classes preset for individual users and service class correspondence data representing service contents corresponding to the service classes are provided as a system in the ISP, and a service corresponding to each user utilizing the internet connection service is provided, as desired, based on the user management data and the service class correspondence data irrespective of connection from any one of the plurality of places.

Advertisement data which have been preliminarily received from an advertisement requester and accumulated are distributed to logged-in users in correspondence to pertinent service classes. Utilization or communication service fees concerning the distribution of the advertisement data to the pertinent users are covered by advertisement fee paid by the advertisement requester to the ISP based on advertisements as the subject of the request. The advertisement data preliminarily received from the advertisement requester and accumulated are further distributed to the pertinent users based on advertisement distribution requests therefrom. An amount obtained by subtracting an advertisement reading fee corresponding to the number of times and frequency of advertisement reading from the internet connection service fee is charged. The number of times of advertisement reading as the basis of discount computation or a value obtained by multiplying the number by a coefficient or a numerical value corresponding to frequency or degree is accumulated and updated as points. The points are as well accumulated and updated with respect to users, who have read advertisements accumulated in TSP managing a system for counting the points from the outside via the internet. Advertisement data preliminarily received from the advertisement requester and accumulated are distributed to logged-in users, and the distribution history such as the number of times and degree of the distribution is accumulated and updated for each advertisement of the advertisement data. A status that advertisement data accumulated by the advertisement requester have been read by the user via the internet, and distribution history such as the number of times and degree of distribution is accumulated and updated for each advertisement of the advertisement data. A status that the user has read advertisements by accessing a system, which is managed by an advertisement distributing dealer accumulating and possessing advertisement data concerning advertisements requested by an advertisement requester, via the internet, and distribution history such as the number of times and frequency of the distribution is accumulated and updated for each advertisement of advertisement data. The system, which is managed by an advertisement management dealer accumulating and possessing advertisement data concerning advertisements requested by an advertisement requester, possesses distribution record data obtained by recording the number of times and degree of advertisement distribution for obtaining a fee corresponding to the number of times and frequency of the advertisement distribution from the advertisement requester. The service classes of the logged-in users are recognized, and services classified by predetermined communication qualities are provided to users. The service classes of the logged-in users are recognized, and services classified based on the kinds of preset accessible media and protocol are provided to users in correspondence to recognized service classes.

An internet connection service system applicable for carrying out the method comprises a network managing server for managing the network utilization state of each of a plurality of users, a rooter for connecting the system to internet, and a service server, the service server being arranged to provide services and charge fees to the users based on service class data for managing service classes capable of being utilized by the users and fee management data for managing the state of fee charging for each user. The fee management data constitutes the basis of charging a fee corresponding to the service class of each user. The service class data are built up by preliminarily setting, by contracts, service classes each applicable to each user. The internet connection service system applicable to carrying out the method further comprises a user management database capable of providing internet connection service in a plurality of different places under management by an ISP (internet service provider) and having data concerning the service classes each preset for each user, and a service class correspondence table representing service contents corresponding to the service classes, respectively, a service being provided, as desired, to each of users utilizing the internet connection service based on the user management database and the service class correspondence table irrespective of the connection of any of the plurality of places.

The internet connection service further comprises an advertisement distributing server for accumulating advertisement data preliminarily received from advertisement requester and distributing the accumulated advertisement data to the users, the advertisement distributing server being applicable to distribute advertisement data to pertinent logged-in users corresponding to service classes recognized by data in the service server.

The service server is arranged such as not to charge any fee for advertisement distribution and communication services required therefor to users.

The service server includes a service class correspondence table for managing the service classes such as to fit advertisement distribution requests each from each user and a fee managing table for managing fees for each user, and distributes advertisement data received from the advertisement requester and accumulated to the pertinent users based on the service class correspondence table to meet the user's advertisement distribution requests.

The fee managing table in the service server is arranged such that the data of each user is updated to an amount obtained by subtracting an advertisement reading fee amount corresponding to the number of times and degree of advertisement reading from the internet connection service utilization fee.

The service server further includes a point managing table for accumulating and updating, as points, a numerical value corresponding to the number of times of advertisement reading as the basis of the discount computation or a value obtained by multiplying the number by a coefficient or a numerical value corresponding to the number of times and degree of advertisement reading.

The service server is arranged to accumulate and update pertinent points regarding users, who have read advertisements accumulated in ISP for managing a point counting system from the outside via internet.

The service server has an arrangement that it possesses distribution history accumulation data obtained for each advertisement of the advertisement data by accumulating and updating the distribution history such as the number of times and degree of the distribution of the advertisement.

The service server has an arrangement that it recognizes the status of reading of advertisement data accumulated by the advertisement requester by the user via internet and possesses distribution history accumulation data obtained for each advertisement of the advertisement data by accumulating and updating the distribution history such as the number of times and frequency of the distribution of the advertisement.

The service server has an arrangement that it recognizes the status of reading of advertisement data by accessing a system, which is managed by an advertisement distributing dealer for accumulating and possessing advertisement data of advertisements concerning the request by an advertisement requester, and possesses distribution history accumulation data obtained by accumulating and updating distribution history such as the number of times and degree of distribution of each advertisement of the advertisement data.

The system managing the advertisement distribution dealer for accumulating and possessing advertisement data of advertisements concerning the request by an advertisement requester, possesses distribution record data obtained by recording the number of times and frequency of advertisement distribution for obtaining a fee corresponding to the number of times and degree of the advertisement distribution from the advertisement requester.

The internet connection service system further comprises a QoS (quality of service) unit for controlling a preset QoS for each user's service class, and the service server has a communication quality managing table, in which communication qualities of services are preset.

The internet connection service system comprises an access control unit for limiting communication media according to preset sections provided for the user's service classes, respectively, and the service server includes a media managing table, in which an accessible media and a protocol are defined for each service class.

Other objects and features will be clarified from the following description with reference to attached drawings.

### BRIEF DESCRIPTION OF THE DRAWINGS

FIG. 1 is a block diagram showing an embodiment of the present invention;

FIG. 2 is a flowchart showing the operation of the embodiment in FIG. 1;

FIG. 3 is a block diagram showing a different embodiment of the present invention;

FIG. 4 is a block diagram showing a further embodiment of the present invention;

FIG. 5 is a flowchart showing the entire operation of the embodiment in FIG. 4;

FIG. 6 is a schematic view showing the function of the embodiment in FIG. 4;

FIG. 7 is a block diagram showing a still further embodiment of the present invention;

FIGS. 8 and 9 are flow charts showing the operation of the embodiment in FIG. 7;

FIG. 10 is a block diagram showing a further embodiment of the present invention;

FIGS. 11 and 12 are flow charts showing the operation of the embodiment in FIG. 10;

FIG. 13 is a block diagram showing other embodiment of the present invention;

FIGS. 14 and 15 are flow charts showing the operation of the embodiment shown in FIG. 13;

FIG. 16 is a block diagram showing a further embodiment of the present invention;

FIG. 17 is a flow charger showing the operation of the embodiment in FIG. 16;

FIG. 18 is a block diagram showing still further embodiment of the present invention;

FIG. 19 is a flow chart showing the entire operation of the embodiment in FIG. 18;

FIG. 20 is a block diagram showing a further embodiment of the invention;

FIG. 21 is a flow chart showing the entire operation of the embodiment in FIG. 20;

FIG. 22 is a block diagram showing other embodiment of the invention;

FIG. 23 is a flow chart showing the operation of the embodiment in FIG. 22; and

FIG. 24 is a view for exemplifying the status of holding data in the data managing table 906.

### PREFERRED EMBODIMENTS OF THE INVENTION

Preferred embodiments of the present invention will now be described with reference to the drawings.

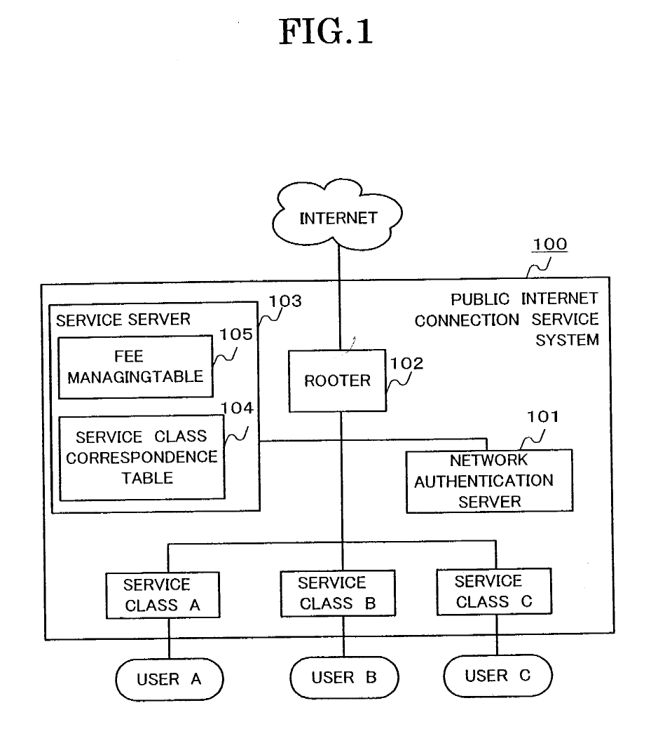

FIG. 1 is a block diagram showing an embodiment of the present invention. A public internet connection service system 100 is shown, which provides a wireless or wired LAN for making internet connection in public places such as internet coffee shops and other hot spots. The system 100 includes a network managing server (hereinafter also referred to as network authentication server) 101 for managing the network utilization status of each of a plurality of users (i.e., users A to C in this example), a rooter 102 for connecting itself to internet and a service server 103 for managing services and fee charging to users.

The service server 103 includes a service class correspondence table 104 for managing service classes capable of being used by users, a fee managing table 105 for managing the fee charging status of each user. The service classes capable of being used by the users are preset according to the contract.

When a user accesses the internet for utilizing a service, a user log-in request is sent out-to the network authentication server 101. The network authentication server 101 requests the user to input a user ID and a password. When the user inputs the user ID and the password, the input value data are sent out to the network authentication server 101, which thus effects a log-in authentication. When the authentication is passed, a log-in is approved. At this time, the network authentication server 101 informs to the service server 103 that the user's log-in has been completed.

The service server 103 recognizes the service class corresponding to the logged-in user from the service class correspondence table 104, and provides a service to the logged-in server. In the illustrated example, service classes A to C corresponds to the users A to C, respectively. Hereinafter, in each Figure the above correspondence relation like symbolic representation is made. The fee charging to the service user is made on the basis of the fee charging managing table 105. When the user ends utilization of the public internet connection service, the use fee is computed based on the fee charging managing table 105 and collected from the user.

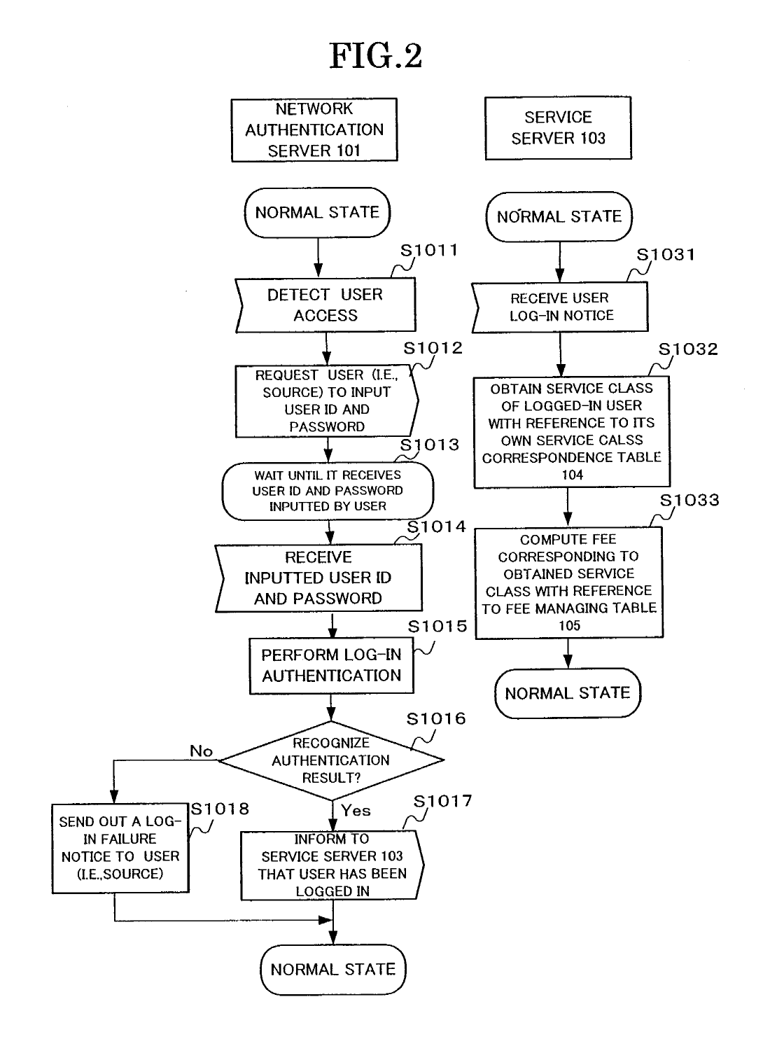

The operation of the first embodiment until a user completes the connection to the public internet connection service system 100 to be ready for service reception, will now be described with reference to a flow chart shown in FIG. 2.

First, when the user accesses the network, the network authentication server 101 detects a user log-in request (step S1011), then requests the user (i.e., source) to input user ID and password (S1012), and then waits until it receives the user ID and the password inputted by the user (step S1013). When the server 101 receives the inputted user ID (S1014), it performs log-in authentication (S1015).

The network authentication server 101 recognizes the authentication result (S1016), and when it recognizes that the authentication is all right, it informs to the service server 103 that user has been logged in (S1017) When the server 101 fails to recognize any successful authentication, it sends out a log-in failure notice to the user (i.e., source) (S1018).

When the service server 103 receives the user log-in notice (S1017) from the network authentication server 101 in the above way (S1031), it obtains the service class of the logged-in user with reference to its own service class correspondence table 104 (step S1032) to provide a service to the logged-in user. The service server 103 also computes the fee corresponding to the obtained service class with reference to the fee managing table 105, in which fee managing data are collected (S1033), and performs fee charging to the logged-in user.

In prior art internet coffees and hot spots, users pay constant fees to be provided with a uniform service. In the above embodiment described with reference to FIGS. 1 and 2, the user can select his or her desired services and pay only a fee corresponding to this service. Since the forms of services (i.e., service classes) are prescribed by the contracts of the individual users, the user side is not necessary to select any service from whenever he or she attempts to utilize a service. It thus causes reduction of cumbersome operation or judgment. The public internet connection service dealer can expect the promotion of the user's system utilization by developing a variety of services.

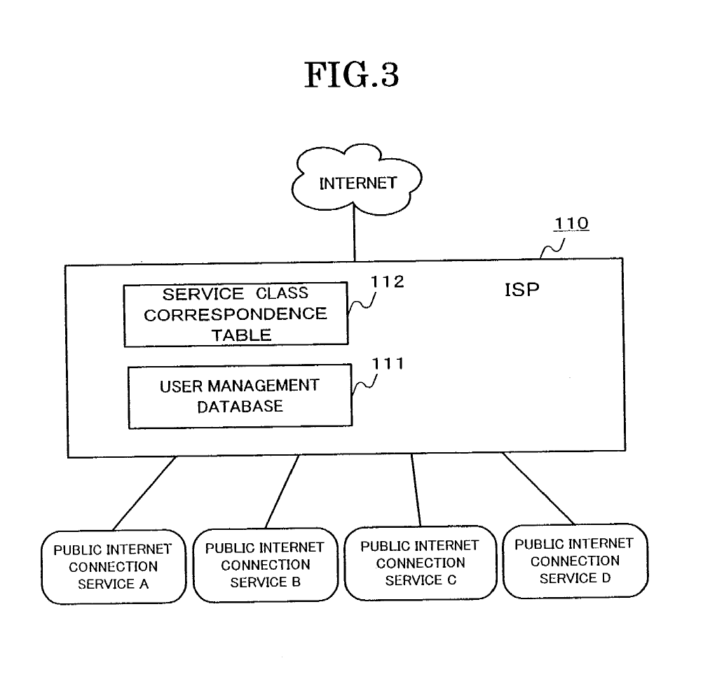

FIG. 3 is a block diagram showing a different embodiment of the present invention. Public internet connection services provided by internet coffee shops or the like include such a case that a certain particular ISP (internet service provider) provides a service at a plurality of locations by using chain shops or the like. In such case of business form, it is possible that an ISP110 system comprising a user management database 111, in which data concerning service classes preset for individual users are collected, and a service class correspondence table 112, in which service contents corresponding to these service cases, respectively, are described to provide different service classes to users utilizing the public internet connection service, and that the user can utilize any desired one of the public internet connection services A to D preset for him or her.

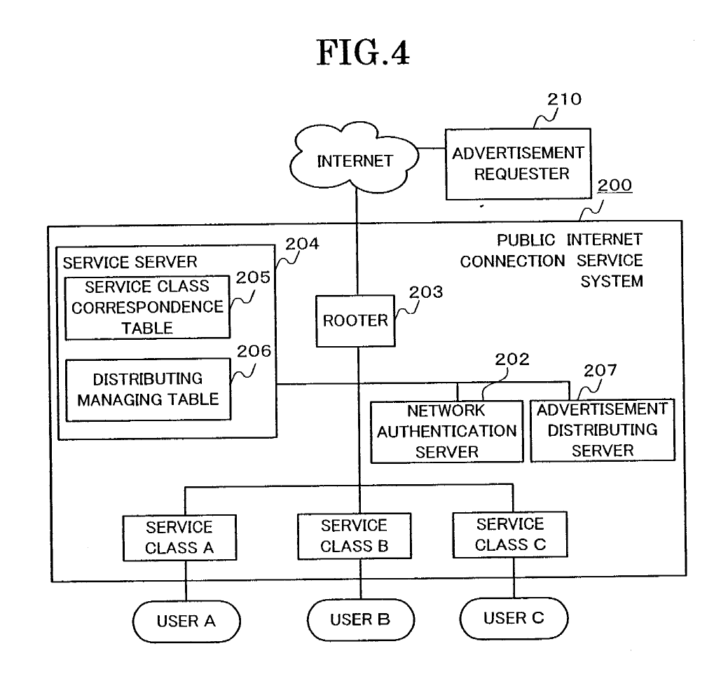

FIG. 4 is a block diagram showing a further embodiment of the present invention. In the FIG. 4 embodiment, a public internet connection service system 200 comprises a network authentication server 202 like the above network managing server (i.e., network authentication server) 101 for performing authentication when the user has been logged in the network, a rooter 203 for connecting the system to the internet, a service server 204 for managing service and fee charging to the user and an advertisement distributing server 207 for accumulating advertisement data received from an advertisement requester 210 and distributing the accumulated advertisement data to users. The service server 204 includes a service class correspondence table 205 for managing service classes for the individual users and a distribution managing table 206, in which advertisement distribution cycles of the individual services are described.

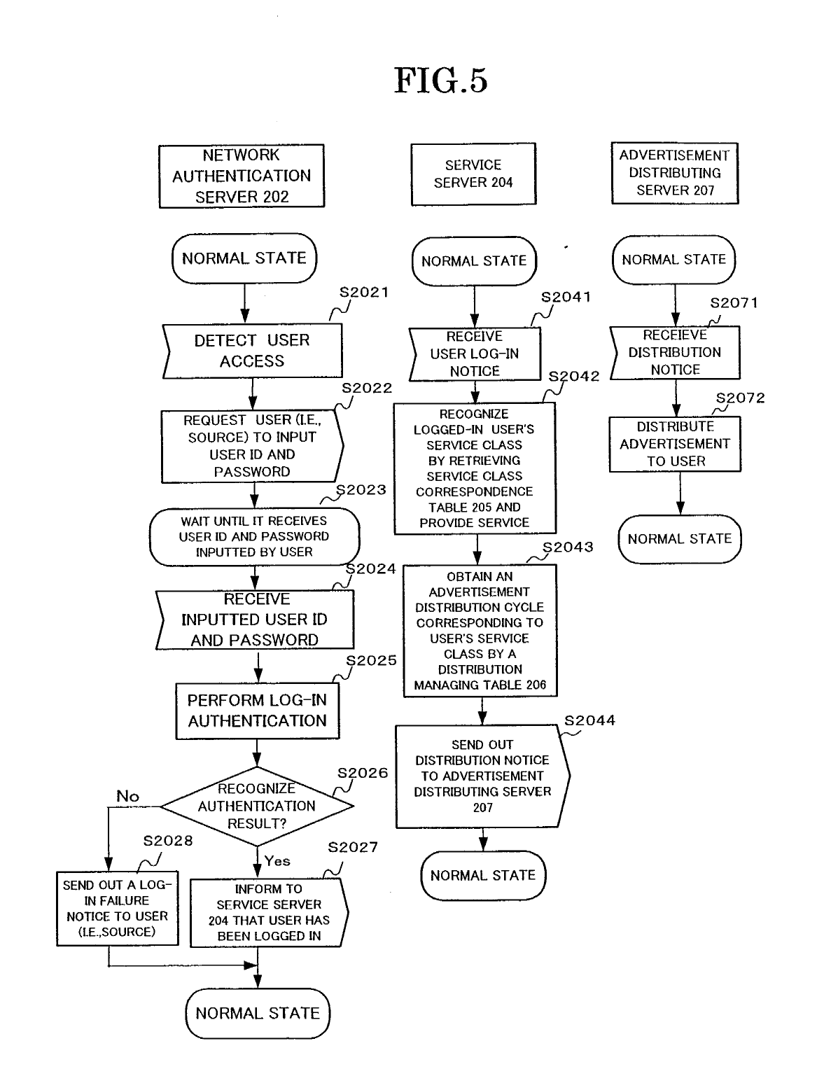

The operation of the FIG. 4 embodiments will now be described with reference to a flow chart shown in FIG. 5.

First, when the user accesses the public internet connection service system 200, the network authentication server 202 detects the user's accessing (S2021), then requires the user to input user ID and password (S2022), and then waits the user ID and the password inputted by the user (S2023) . When the network authentication server 202 receives the inputted user ID and password (S2024), the network authentication server 202 performs log-in authentication by matching the registered user ID and password (S2025). The network authentication sever 202 then recognizes the authentication result (S2026) When the network authentication server 202 recognizes the authentication result to be identical, it informs to the service server 204 that user log-in has been completed (S2027). When the network authentication server 202 fails to recognize the authentication result to be identical, it informs to the user (i.e., transmission source) that user log-in could not have been performed (S2028).

When the service server 204 receives the user log-in notice (S2041), it recognizes the logged-in user's service class by retrieving the service class correspondence table 205, and provides the service corresponding to the recognized service class (S2042). Then, the service server 204 obtains an advertisement distribution cycle, for instance, as one advertisement distribution form corresponding to the user's service class (S2043), and sends out a distribution notice to the advertisement distributing server 207 (S2044) . When the advertisement distributing server 207 receives the distribution notice (S2071), it distributes advertisement data which have been received form the advertisement requester 21 and accumulated in advance in a state prescribed in the step S2043 (S2072).

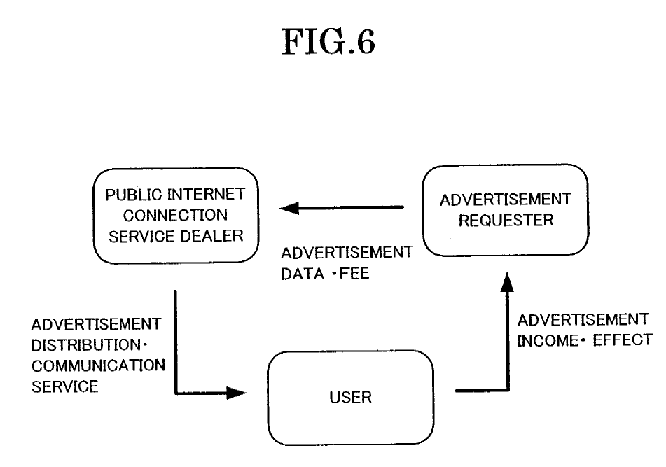

FIG. 6 is a schematic view showing the function of the FIG. 4 system described above with reference to the flow chart of FIG. 5. As will be understood from FIGS. 5 and 6, the fee of advertisement distribution from a public internet connection service dealer to users and pertinent communication service fees are covered by an advertisement fee paid by the advertisement requester to the advertisement as the subject of request. In other words, the service server of the system managed by the public internet connection service dealer is arranged such that neither advertisement distribution fee nor pertinent communication service fee is charged to any user. Thus, the user can utilize the public internet connection service without bearing any utilization fee, the public internet connection service dealer can obtain advertisement income, and the advertisement requester can obtain advertisement effects.

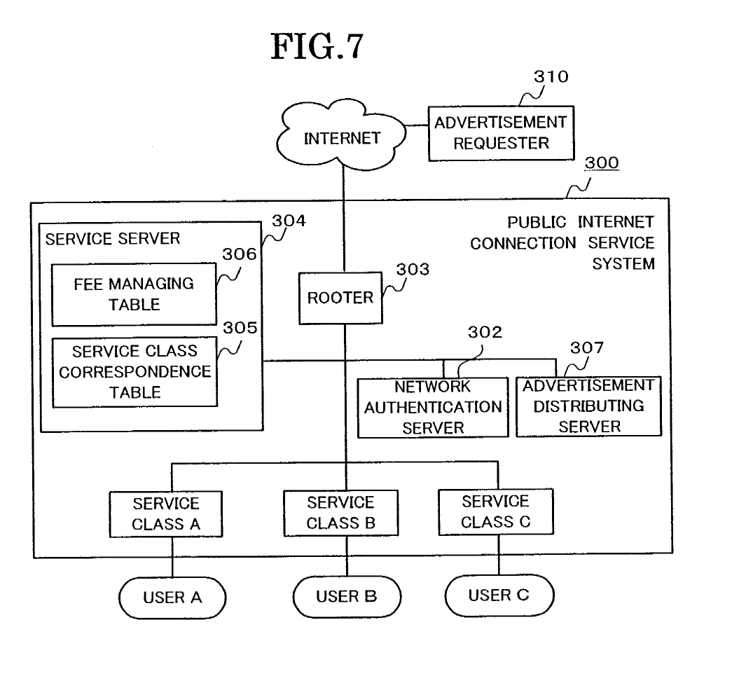

FIG. 7 is a block diagram showing a further embodiment of the present invention. In the FIG. 7 embodiment, a public internet connection service system 300 comprises a network authentication server 302 like the above network managing server (i.e., network authentication server) 101 for performing authentication when the user has been logged in the network, a rooter 303 for connecting the system to the internet, a service server 304 for providing services and charging fees to users, and an advertisement distributing server 307 for accumulating advertisement data received from an advertisement requester 310 and distributing the accumulated advertisement data to users. The service server 304 includes a service class correspondence table 305 for managing service classes for the individual users and a fee managing table 306 for managing fees for the individual users.

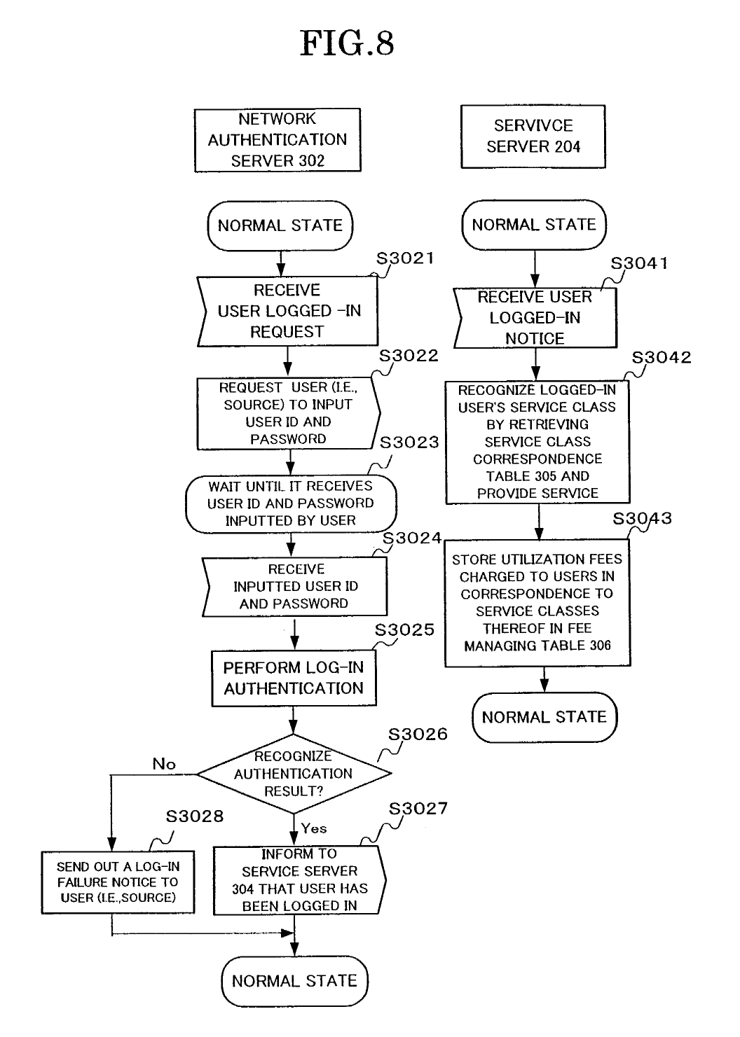

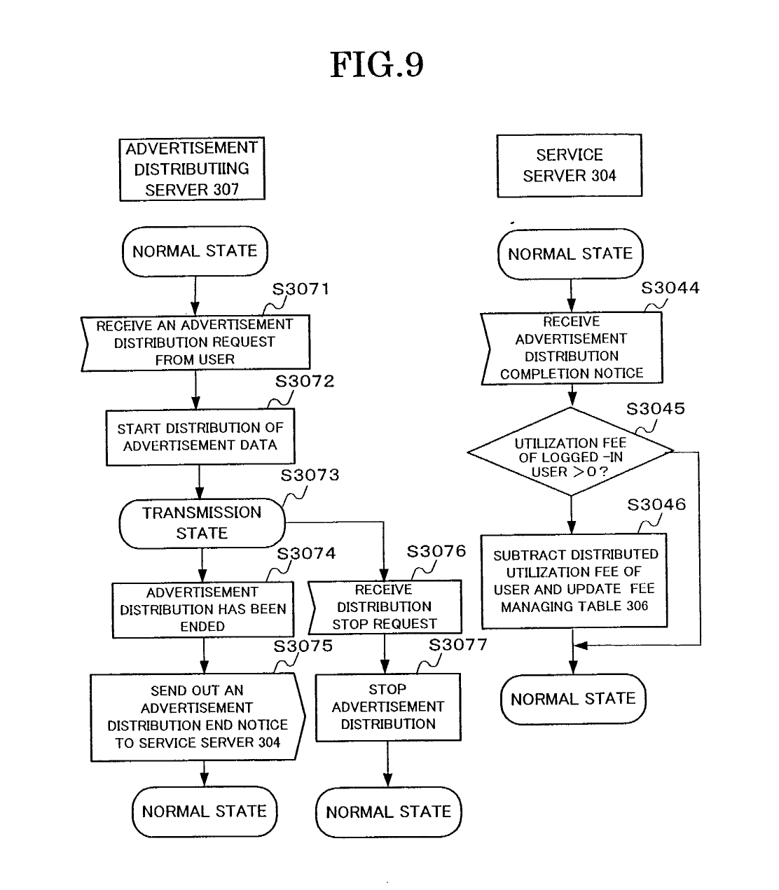

FIGS. 8 and 9 are flow charts showing the operation of the FIG. 7 embodiment.

First, when the user accesses the public internet connection service system 300, the network authentication server 302 detects this (S3021), then requests the user to input user ID and password (S3022), and then waits the reception of user ID and password by the use (S3023) . When the network authentication server 302 receives the user ID and password (S3024), it performs log-in authentication by matching the registered user ID and password (S3025), and recognizes the authentication result (S3026). When the network authentication server 302 recognizes the result to be identical, it informs the service server 304 that user log-in has been made (S3027). When the network authentication server 302 fails to recognize the result to be identical, it sends out a log-in failure notice to the user (i.e., transmission source) (S3028).

When the service server 304 receives the user log-in notice (S3041), it recognizes the service class of the logged-in user by retrieving the service class correspondence table 305, then provides a service corresponding to the recognized service class (S3042) to users and then stores the utilization fees charged to the users in correspondence to the service classes thereof in the fee managing table 306 (S3043).

The user accesses the advertisement distributing server 307 for reading advertisements within a utilization time for the purpose of reducing the service utilization fee. When the advertisement distributing server 307 receives an advertisement distribution request from the user (S3071), it starts distribution of advertisement data, which have been received from the advertisement requester 310, to the user (S3072). Then, the advertisement distributing server 307 allows communication for this distribution (S3073) . When the advertisement distribution has been ended (S3074), the advertisement distributing server 307 sends out an advertisement distribution end notice to the service server 304 (S3075).

The number of times and frequency of the advertisement distribution usually directly corresponds to the number of times and frequency of the advertisement reading by the user. When the user receives a distribution stop request before completion of the advertisement distribution (S3076), the advertisement distributing server 307 stops the advertisement distribution (S3077), and sends out no notice. When the service server 304 receives the above advertisement distribution completion notice (in the S3075) (S3044), it checks whether the utilization fee of the logged-in user is more than zero (S3045) . When the utilization fee is more than zero, the service server 304 updates the fee managing table 306 by subtracting advertisement reading fee corresponding to the number of times and frequency of the above advertisement reading from the utilization fee (S3046).

Thus, the user can reduce or make zero the service utilization fee by reading advertisements of desired contents not in a fixed cycle period as determined in the system but in a time as desired by the user.

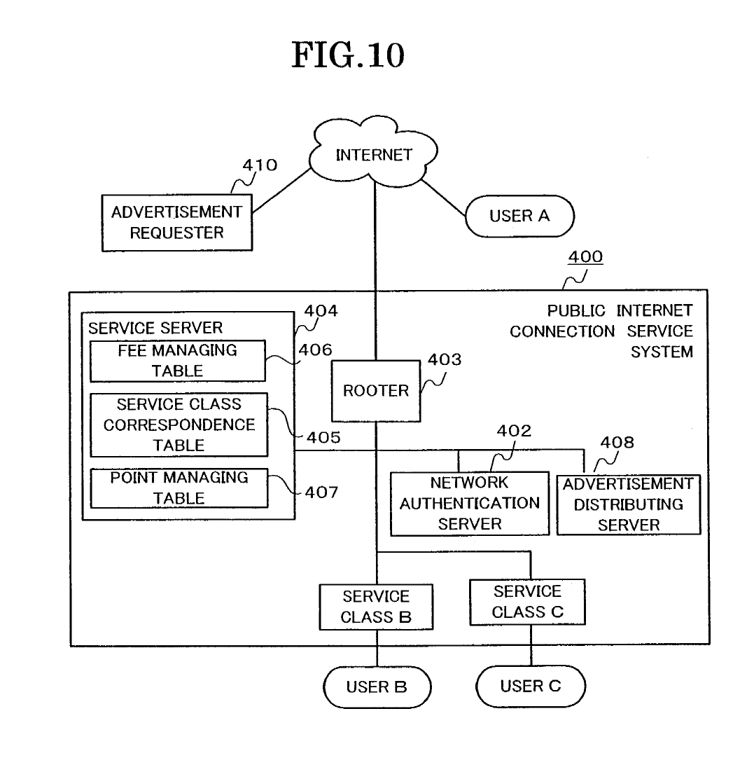

FIG. 10 is a block diagram showing a further embodiment of the present invention. Referring to the Figure, a public internet connection service system 400 in this embodiment includes a network authentication server 402 like network managing server (i.e., network authentication server) 101 for performing authentication when the user has been logged in the network, a rooter 403 for connecting the system to the internet, a service server 404 for managing services provided and fee charging to users, and an advertisement distributing server 408 for accumulating advertisement data received from an advertisement requester 410 and distributing the accumulated advertisement data to users The service server 404 has a service class correspondence table 405 for managing service classes for the individual users, a fee managing table 406 for managing fees for the individual users, and a point managing table 407 for accumulating each user's accumulating advertisement reading points, i.e., the number of times of advertisement reading or values obtained by multiplying the number of times by a coefficient or value corresponding to the frequency or the number of times of reading.

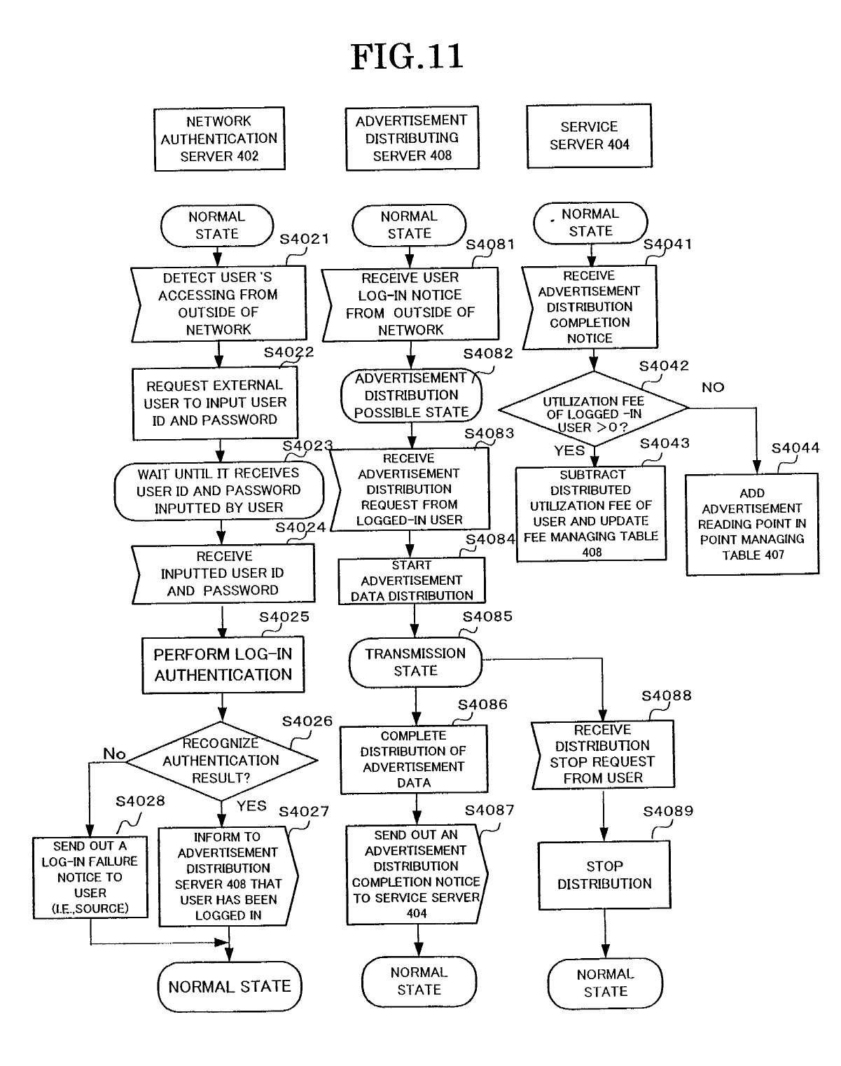

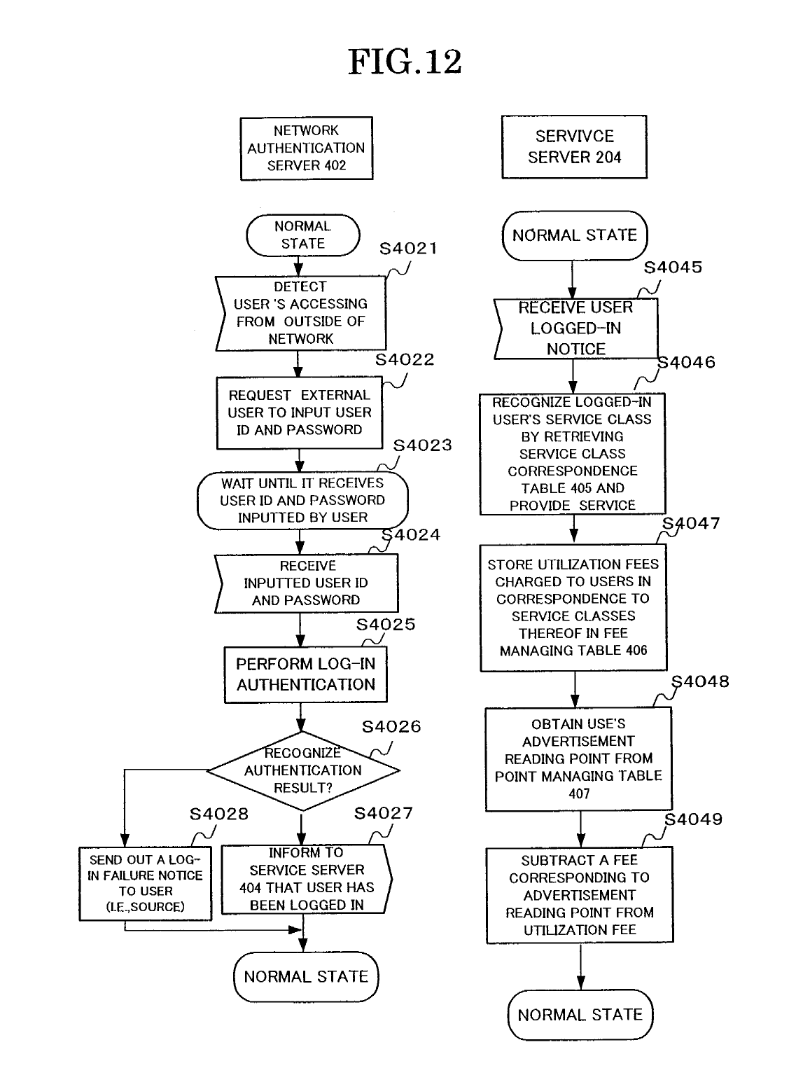

FIGS. 11 and 12 are flow charts showing the operation of the FIG. 10 embodiment. First, the user accesses the public internet connection service system 400 from the outside of the internet. At this time, the network authentication server 402 detects user's accessing from the outside of the network (S4021), then requests the external user to input user ID and password (S4022), and then waits the reception of the user ID and password inputted by the user (S4023) . When the user ID and password are received (S4024), the network authentication server 402 performs log-in authentication by matching the registered user ID and password (S4025) . The network authentication server 402 recognizes the result of authentication (S4026). When the network authentication server 402 recognizes identity, it informs to the advertisement distributing server 408 that the user has been logged in (S4027) . When the network authentication server 402 fails to recognize identity, it sends out a log-in failure notice to the user (i.e., communication source) (S4028).

When the advertisement distributing server 408 receives the user log-in notice from the outside of the network (S4081), the logged-in user becomes possible to perform advertisement distribution (S4082) . Afterwards, when the advertisement distributing server 408 receives an advertisement distribution request from the logged-in user (S4083), it starts advertisement data distribution (S4084). The transmission state for this distribution is continued for a predetermined period of time (S4085). When the advertisement distributing server 408 completes the distribution of the advertisement data (S4086), it sends out an advertisement distribution completion notice to the service server 404 (S4087) . When the advertisement distributing server 408 receives a distribution stop request from the user before completion of the distribution (S4088), it stops the distribution (S4089).

When the service server 404 receives. the advertisement distribution completion notice (S4041), it checks whether the present service utilization fee of the user is more than zero (S4042) . When the fee is more than zero, the service server 404 updates the fee managing table 406 by subtracting a fee corresponding to the advertisement reading from the utilization fee (S4043). When the fee is zero, the service server 404 adds the advertisement reading point in the point managing table 407 (S4044).

Now, the operation in the case of public internet connection service utilization by the user will be described. First, when the user accesses the public internet connection service system 400, the network authentication server 402 detects the user's accessing (S4021), then requests the outside user to input user ID and password (S4022), and waits the reception of user ID and password inputted by the user (S4023) . When the network authentication server 402 receives the inputted user ID and password (S4024), it performs log-in authentication by matching the registered user ID and password (S4025) . The network authentication server 402 recognizes the result of authentication (S4026) . When the network authentication server 402 recognizes identity, it informs to the advertisement distribution server 408 that the user has been logged in (S4027) . When the network authentication server 404 fails to recognize identify, it sends out a log-in failure notice to the user (i.e., communication source) (S4028).

When the service server 404 receives the user log-in notice (S4045), it recognizes the service class of the logged-in user by retrieving the service class correspondence table 405, then provides a service corresponding to the recognized service class (S4046), and stores a utilization fee corresponding to the user's service class in the fee managing table 406 (S4047) . The service server 404 then obtains the user's advertisement reading point from the point managing table 407 (S4048), and subtracts a fee corresponding to the advertisement reading point from the utilization fee (S4049) . More specifically, the service server 404 charges an amount obtained by subtracting the advertisement reading amount corresponding to the number of times and frequency of the advertisement reading from the internet connection service utilization fee. Thus, the user can perform accessing not only within the service utilization time but also from the outside of the network, i.e., from a desired place, in a desired time for the advertisement reading, thus reducing or making zero the service utilization fee.

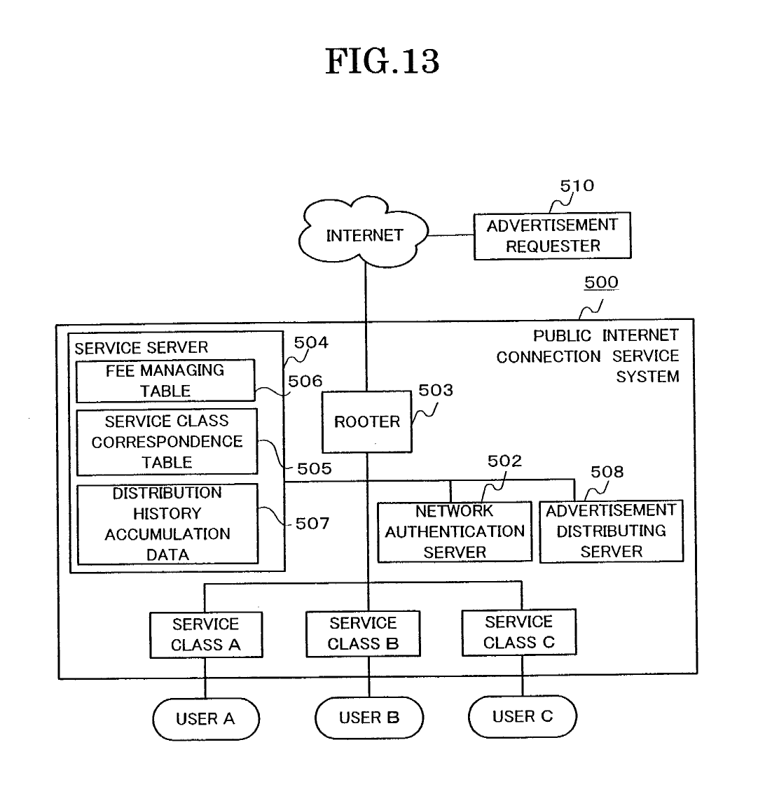

FIG. 13 is a block diagram showing a further embodiment of the present invention. The system shown in FIG. 13 is obtained by adding a distribution history accumulation data 507, which permit accumulation and updating advertisement distribution histories of individual advertisements, to the public internet connection service system described before with reference to FIG. 7, and it permits grasping the degree of user's interest on each advertisement by collecting advertisement distribution history data.

Referring to FIG. 13, a public internet connection service system 500 includes a network authentication server 502 like network managing server (i.e., network authentication server) 101, described before, for performing authentication when the user is logged in the network, a rooter 503 for connecting the system to the internet, a service server 504 for managing the service provided and fee charging to the user, and an advertisement distributing server 508 for accumulating advertisement data received from the advertisement requester 510 and distributing the accumulated advertisement data to users. The service server 504 has a service class correspondence table 505 for managing service classes of individual users, a fee managing table 506 for managing fees of the individual users, and distribution history accumulation data 507 permitting accumulation and updating of advertisement distribution histories.

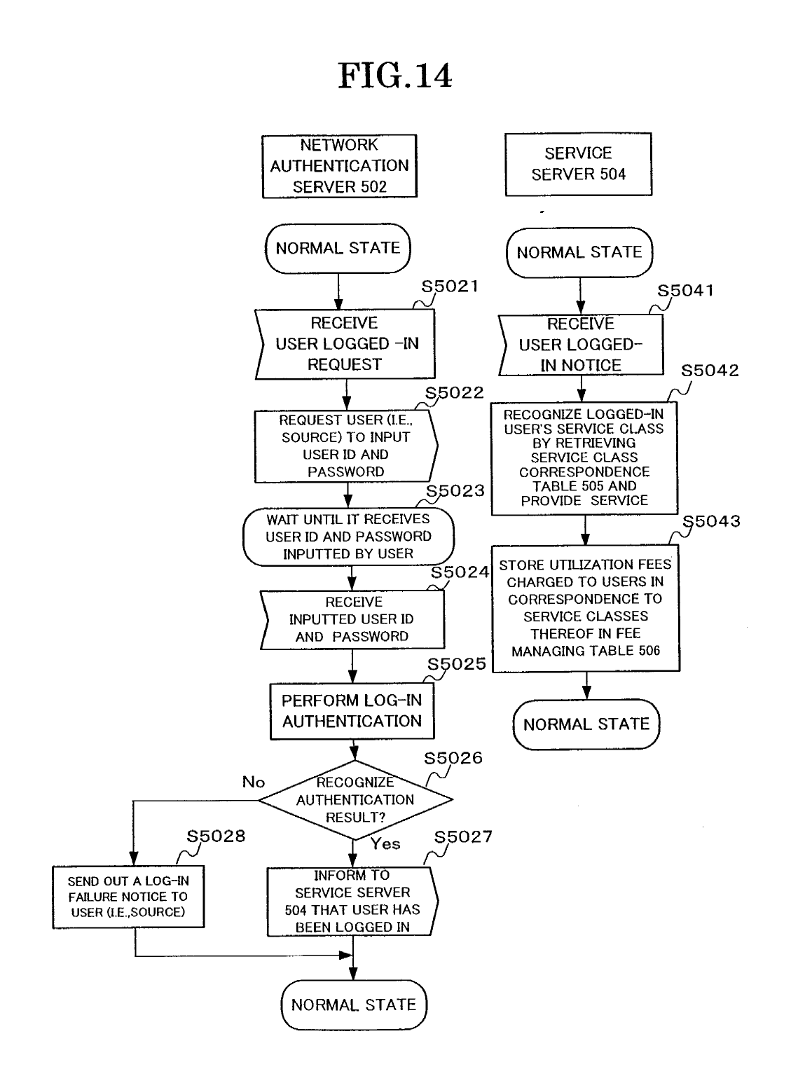

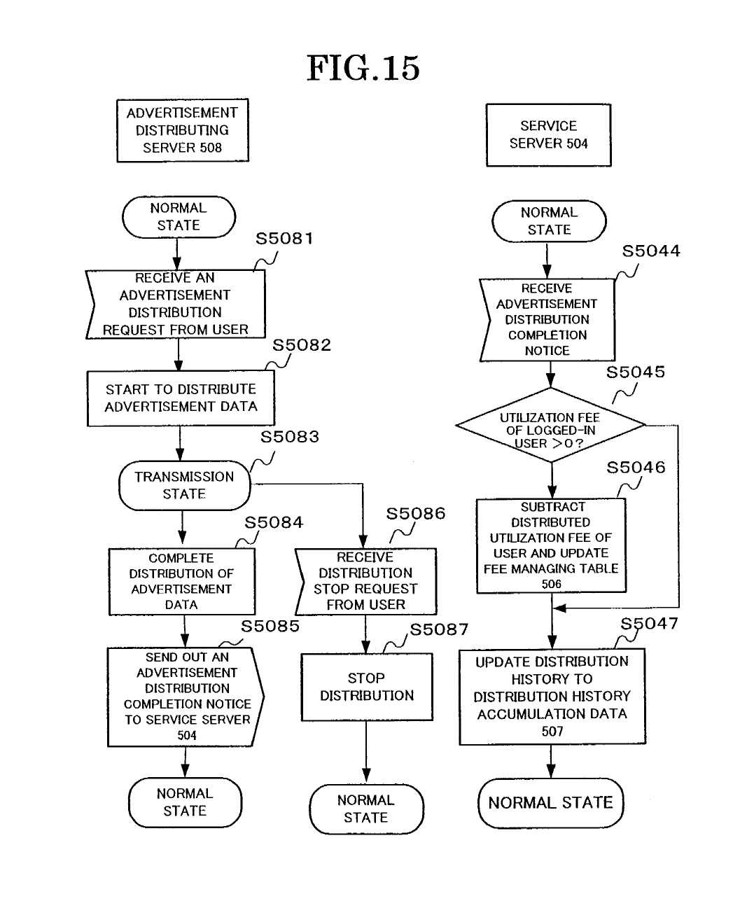

FIGS. 14 and 15 are flow charts showing the operation of the embodiment shown in FIG. 13. First, when the user accesses the public internet connection service system 500, the network authentication server 502 detects the user's accessing (S5021), then requests the user to input user ID and password (S5022), and waits for the reception of the user ID and password inputted by the user (S5023). When the network authentication server 502 receives the inputted user ID and password (S5024), it performs log-in authentication by matching the registered user ID and passwords (S5025). The network authentication server 502 recognizes the result of authentication (S5026). When the network authentication server 504 recognizes identity, it informs to the service server 504 that the user has been logged in (S5027). When the network authentication server 504 fails to recognize identity, it sends out a log-in failure notice to the user (i.e., transmission source) (S5028).

When the service server 504 receives the user log-in notice (S5041), it recognizes the service class of the logged-in user by retrieving the service class correspondence table 505 to provide a service corresponding to the service class to the user (SS042), and stores a utilization fee corresponding to the user's service class to the fee managing table 506 (S5043). The user accesses the advertisement distributing server 508 for reading advertisements within a utilization time for the purpose of reducing the service utilization fee.

When the advertisement distributing server 508 receives an advertisement distribution request from the user (S5081), it starts distribution to advertisement data users preliminarily received from the advertisement request 510 (S5082). The communication for the distribution is thus made (S5083) . When the advertisement distribution has been completed (S5084), it sends out an advertisement distribution completion notice to the service server 504 (S5085). When the service server 504 receives a distribution stop request from the user before completion of the advertisement distribution (S5086), it stops the advertisement distribution (S5087), and sends out no notice. When the service server 504 receives the above advertisement distribution completion notice (in step S5085) (S5044), it checks whether the utilization fee of logged-in user is more than zero (S5045) . When the utilization fee is more than zero, the service server 504 updates the fee managing table 506 by subtracting a fee corresponding to advertisement reading from the utilization fee (S5046) The user thus can reduce or make zero the service utilization fee by reading advertisements of desired contents not in a fixed cycle period predetermined in the system but a user's desired time.

A featuring point of the FIG. 13 embodiment in comparison to the other embodiments resides in that when the service server 504 receives an advertisement distribution completion notice from the advertisement distributing server 508 (S5044), it updates the logged-in user's fee charging data in the fee charging managing table 506 (S5046) and also updates the distribution history such as the number of times and frequency of the distribution for each advertisement accumulated as the distribution history accumulation data 507 (S5047) . It is thus possible to obtain internet degree data of each advertisement by using the advertisement distribution data and profile high addition value data to the advertisement requester 510.

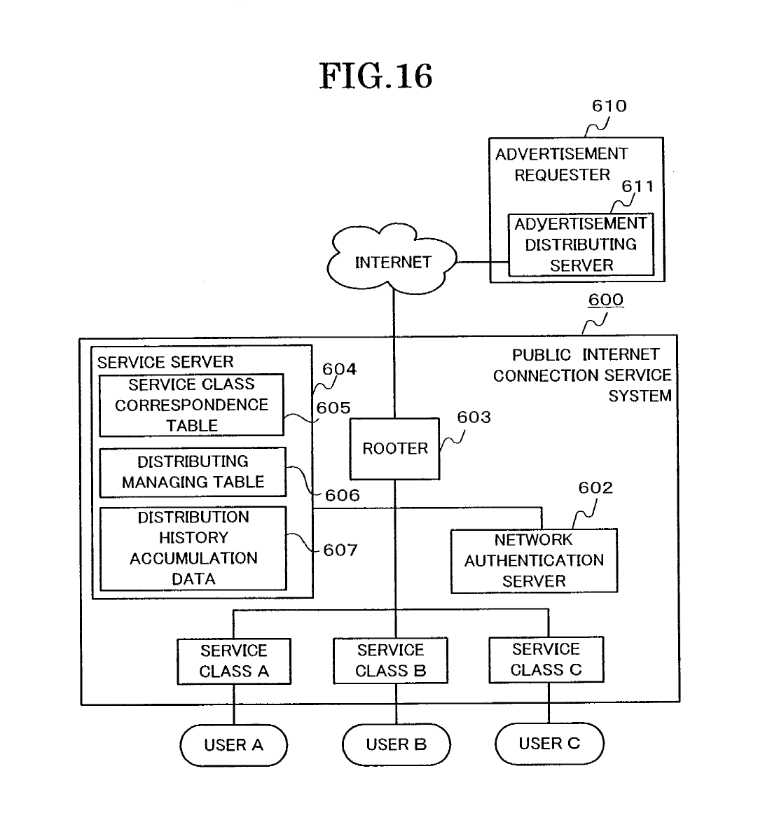

FIG. 16 is a block diagram showing a further embodiment of the present invention. In this embodiment, a public internet connection service system 600 includes a network authentication server 602 for performing authentication when the user has been logged in the network, a rooter 603 for connecting the system to an outside internet, and a service server 604 for providing services to and managing users. The service server 604 includes a service class correspondence table 605 for managing service classes for individual-users, a distribution managing table 606, in which advertisement distribution cycles of individual services are described, and a distribution history accumulation data 607 for accumulating and updating the number of times and frequency for the distribution. The advertisement requester 610 includes an advertisement distribution server 611, in which advertisement data for distribution are accumulated.

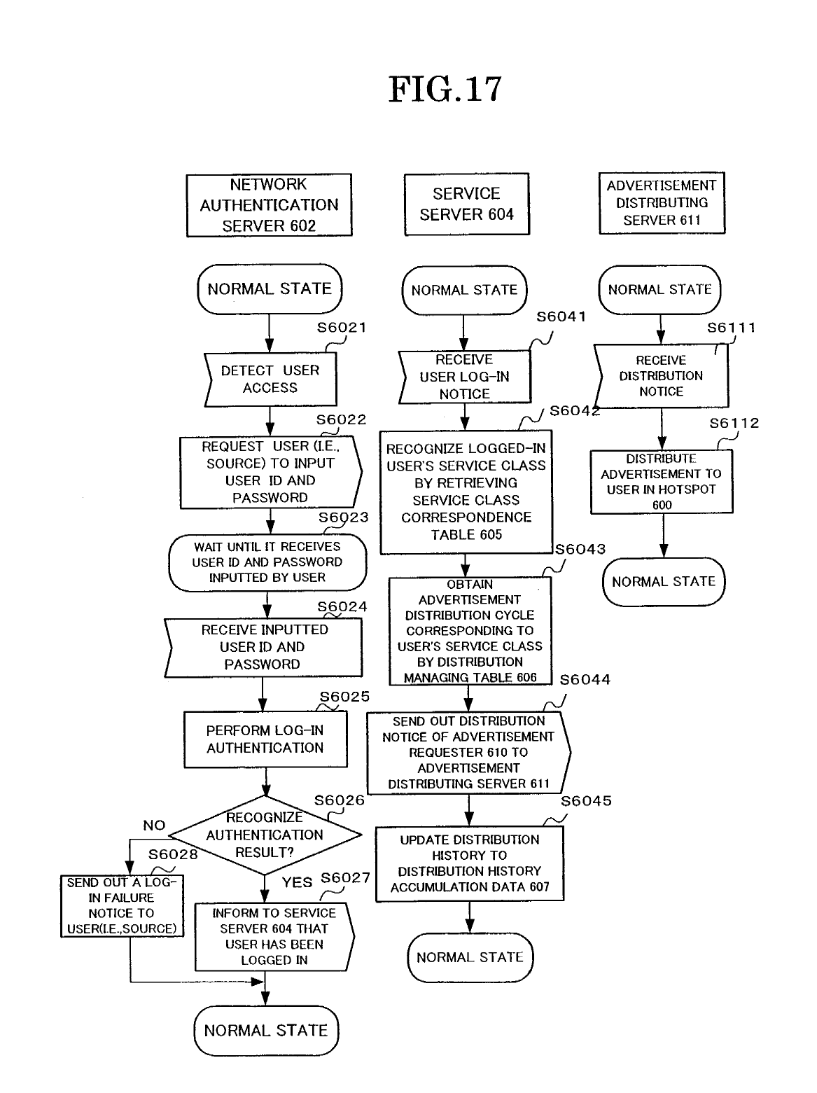

FIG. 17 is a flow charger showing the operation of the entire system shown in FIG. 16. In the Figure, first when the user accesses the public internet connection service system 600, the network authentication server 602 detects the user's accessing (S6021), then requests the user to input user ID and password (S6022), and waits for the reception of the user ID and password inputted by the user (S6023). When the network authentication server 602 receives the inputted user ID and password (S6024), the network authentication server 602 performs log-in authentication by matching the registered user ID and password (S6025) . The network authentication server 602 recognizes the result of authentication (S6026). When the network authentication server 602 informs to the service server 604 that the user has been logged in (S6027). When the network authentication server 602 fails to recognize identity, the network authentication server 602 sends out a log-in failure notice to the user (i.e., transmission source) (S6028)

When the service server 604 receives the user log-in notice (S6041), it recognizes the logged-in user's service class by retrieving the service class correspondence table 605 (S6042), then obtains the advertisement distribution cycle corresponding to the service class with reference to the distribution managing table 606 (S6043), and sends out a request for advertisement distribution to the logged-in user to the advertisement distributing dealer (S6044). Then, the service server 604 updates the number of times and frequency of the distribution of the distribution history accumulation data 607 (S6045). When the advertisement distributing server 611 receives a distribution notice (S6111), it distributes preliminarily accumulated advertisement data to the logged-in user (S6112) . Thus, unlike the previous embodiment it is no longer necessary to provide any advertisement distributing server in the public internet connection dealer. It is thus possible to reduce the equipment investment. Since the advertisement distributing server has its own equipment, the advertisement requester side can freely update the distribution data without need of any procedure such as one at the time of advertisement data updating, and thus can freely perform updating.

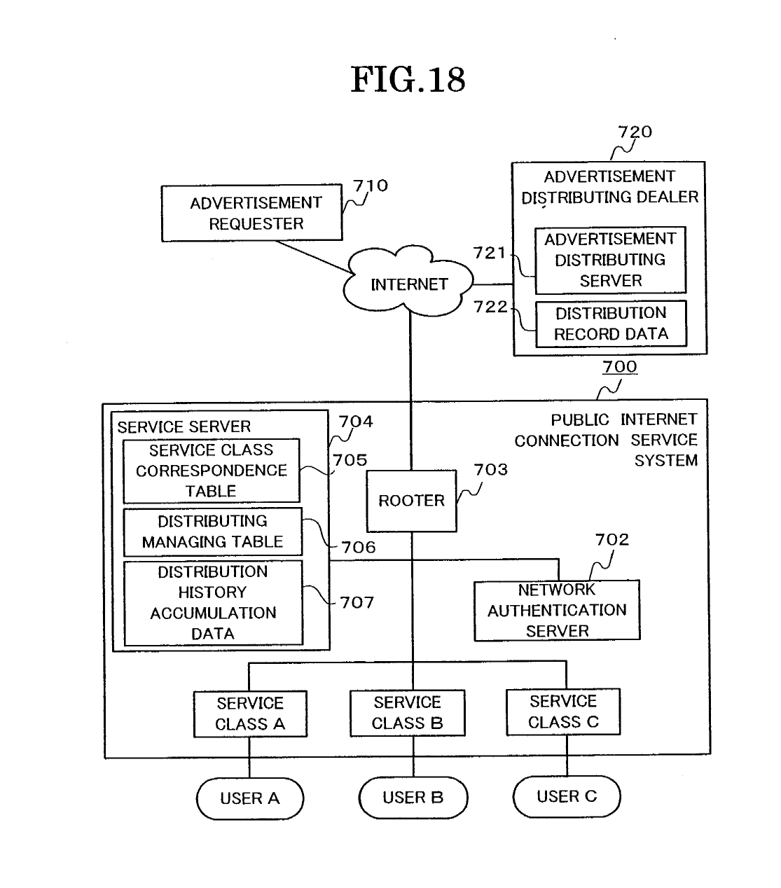

FIG. 18 is a block diagram showing a further embodiment of the present invention. In this embodiment, a public internet connection service system 700 includes a network authentication server 702 for performing authentication when the user is logged in the network, a rooter 703 for connecting the system to outside internet, and a service server 704 for providing services to and managing users. The service server 704 has a service class correspondence table 705 for managing the service classes of individual users, a distribution managing table 706, in which the advertisement distribution cycles of the individual services, and distribution history accumulation data 707 obtained by accumulating the number of times and frequency of distribution. The public internet connection service system 700 is coupled via the internet to an advertisement requester 710.

The FIG. 18 system is a public internet connection service system like the embodiment described above with reference to FIG. 16. In this system an advertisement distributing dealer 720 for distributing advertisements (i.e., a system managed by the same advertisement distributing dealer) is disposed as an internet system between the advertisement requester 710 and the public internet connection service system 700. The advertisement distributing dealer 720 includes an advertisement distributing server 721 for accumulating advertisement distribution data received from a plurality of advertisement requesters 710 and distributing the accumulated advertisement distribution data to a plurality of public internet connection service systems 700, and distribution record data 722 for recording the number of times and frequency of advertisement distribution and obtaining fees corresponding to the number of times and frequency of distribution from the advertisement requesters.

In the FIG. 18 embodiment, the advertisement requesters 710 need not conclude any contract with a plurality of public internet connection service dealers, and can simplify the advertisement distribution procedure by setting a single advertisement distributing dealer as destination of advertisement data registration. Also, the public internet connection service dealers need not conclude any contract with the plurality of advertisement requesters, and can simplify the system by setting a single place of access to the advertisement distributing servers.

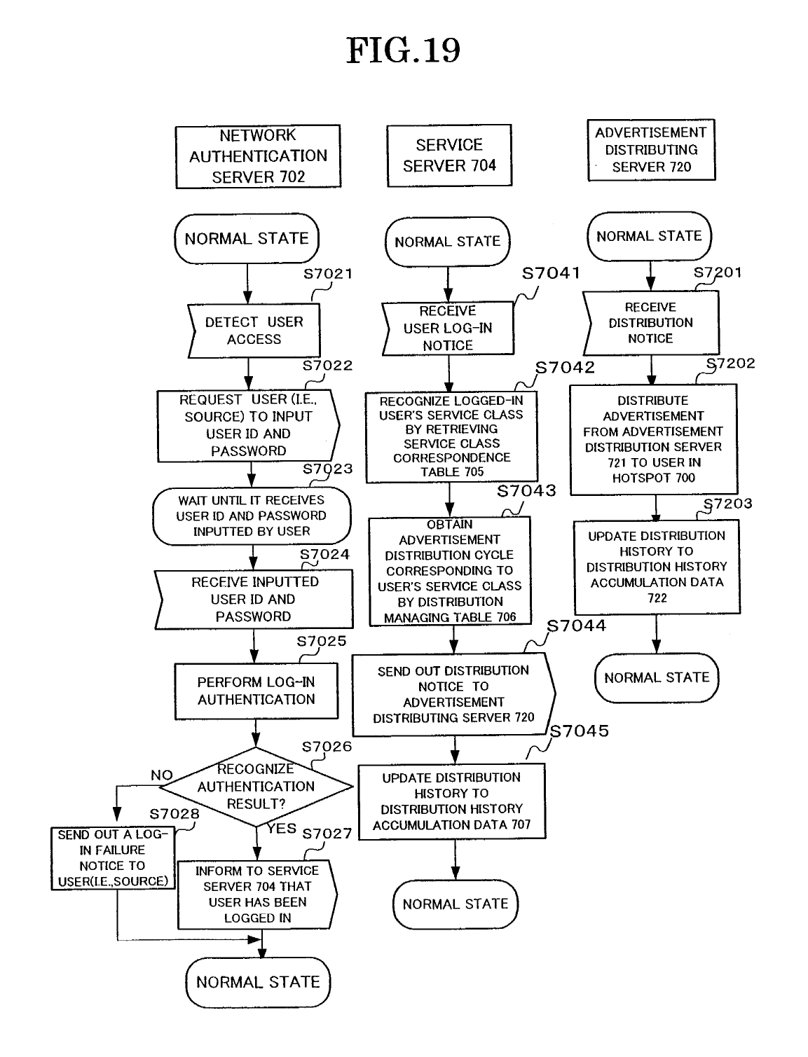

FIG. 19 is a flow chart showing the operation of the entire FIG. 18 system.

In the Figure, first when the user accesses the public internet connection service system 700, the network authentication server 702 detects the user's accessing (S7021), then requests the user to input to input user ID and password (S7022), and waits for the reception of the user ID and password inputted by the user (S7023). When the internet authentication server 802 receives the inputted user ID and password (S7024), it performs log-in authentication by matching the registered user ID and password (S7025). The network authentication server 702 recognizes the result of authentication (S7026). When the network authentication server 702 recognizes identity, it informs to the service server 704 that the user has been logged in (S7027). When the network authentication server 702 fails to recognize identify, it sends out log-in failure notice to the user (i.e., transmission source) (S7028).

When the service server 704 receives the user log-in notice (S7041), it recognizes the logged-in user's service class by retrieving the service class correspondence table 705 (S7042), then obtains the advertisement distribution cycle corresponding to the service class with reference to the distribution managing table 706 (S7043), and then sends out a request of advertisement distribution to the logged-In user to the advertisement distributing dealer 720 (S7044). Then, the service server 704 updates the number of times and frequency of distribution of the distribution history accumulation data 707 (S7045). This embodiment is different from the previous embodiments in the above step S7044 and the following action on the side of the advertisement distributing dealer 720. When the advertisement distributing dealer 720 receives the advertisement distribution request (S7201), it distributes advertisement data to the user by utilizing the advertisement distributing server 721 (S7202), and updates the number of times and frequency of distribution of each advertisement of the distribution record data 722 (S7203).

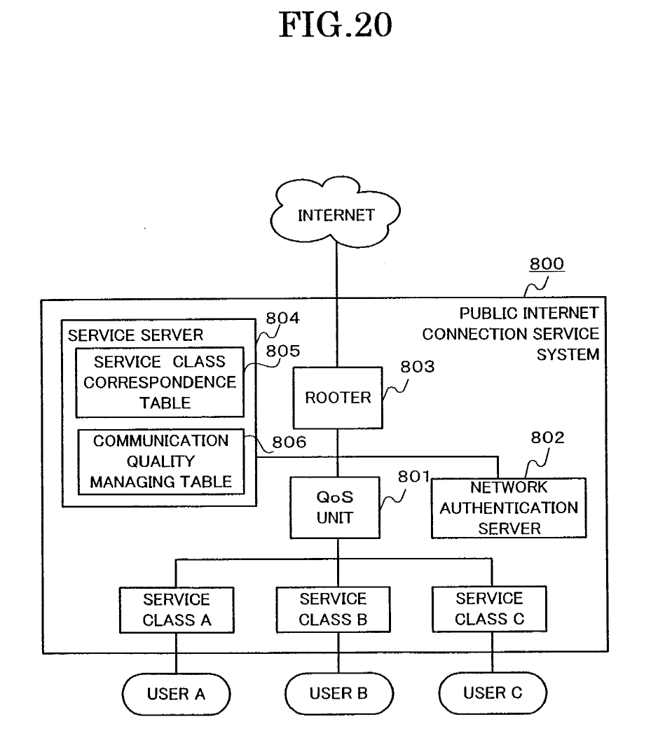

FIG. 20 is a block diagram showing a further embodiment of the invention. In this embodiment, a public internet connection service system 800 includes a QoS unit 801 for controlling the QoS (quantity of service) for classifying the service quality, a network authentication server 802 for performing authentication when the user is logged in the network, a rooter 803 for connecting the system with an outside internet and a service server 804 for providing services and managing users. The service server 804 has a service class correspondence table 805 for managing service classes for users and a communication quality managing table 806.

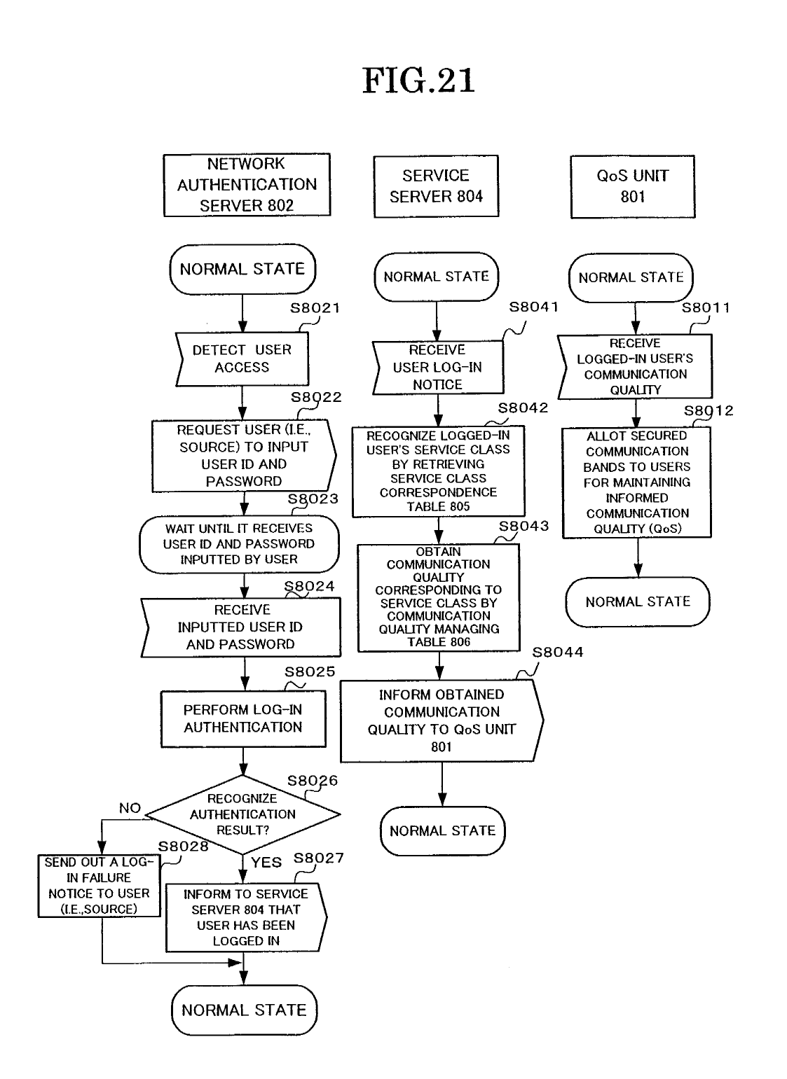

The operation of the FIG. 20 embodiment as a whole will now be described with reference to the flow chart shown in FIG. 21. When the user accesses the public internet connection service system 800, the network authentication server 802 detects the user's accessing (S8021), requests the user to input user ID and password by the user (S8022), and waits for the reception of the user ID and password inputted by the user (S8023). When the network authentication server 802 receives the inputted user ID and password (S8024), the network authentication server 802 performs log-in authentication by matching the registered user ID and password (S8025).

The network authentication server 802 recognizes the result of authentication (S8026) . When the network authentication server 802 recognizes authentication, the network authentication server 802 informs to the service server 804 that the user has been logged in (S8027). When the network authentication server 802 fails to recognize the authentication, it sends out a log-in failure notice to the user (i.e., transmission source) (S8028) . When the service server 804 receives the user log-in notice (S8041), it recognizes the service class of the logged-in user by retrieving the service class correspondence table 805 (S8042), obtains the communication quality corresponding to the service class (S8043), and informs the obtained communication quality to the QoS unit 801 (S8044).

When the QoS unit 801 receives the logged-in user's communication quality (S8011), it secures communication bands for maintaining the informed communication quality (QoS), and allots the secured communication bands to the users (S8012), so that it can provide classified services.

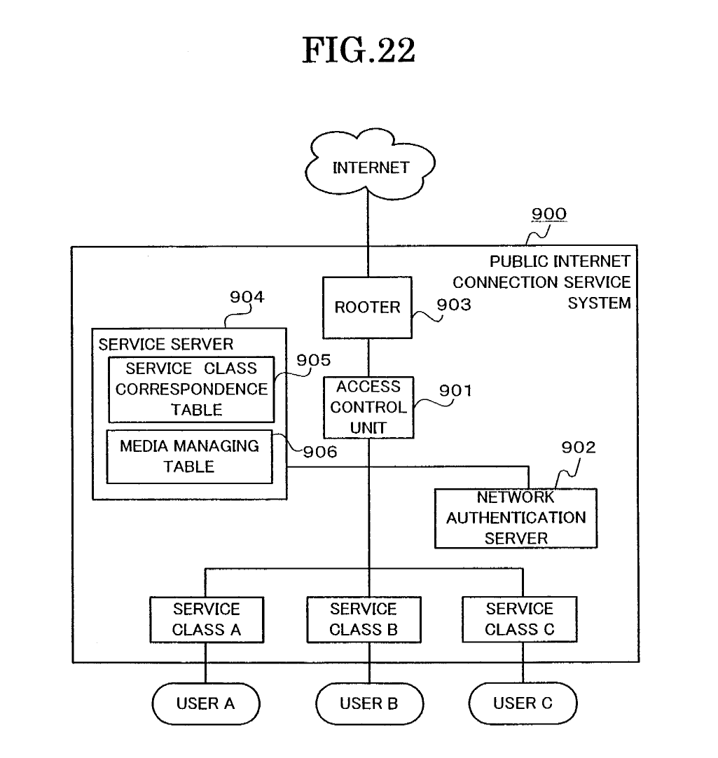

FIG. 22 is a block diagram showing a further embodiment of the invention. In the Figure, a public internet connection service system 900 includes an access control unit 901 for controlling communication media for sorting out the service quality, a network authentication server 902 for performing authentication when the user is logged in the network, a rooter 903 for connecting the system to an outside internet, and a service server 904 for providing services and managing users. The service server 904 has a service class correspondence table 905 for managing the service classes of the individual users, and a media managing table 906 for defining media and protocol capable of being accessed for each user.

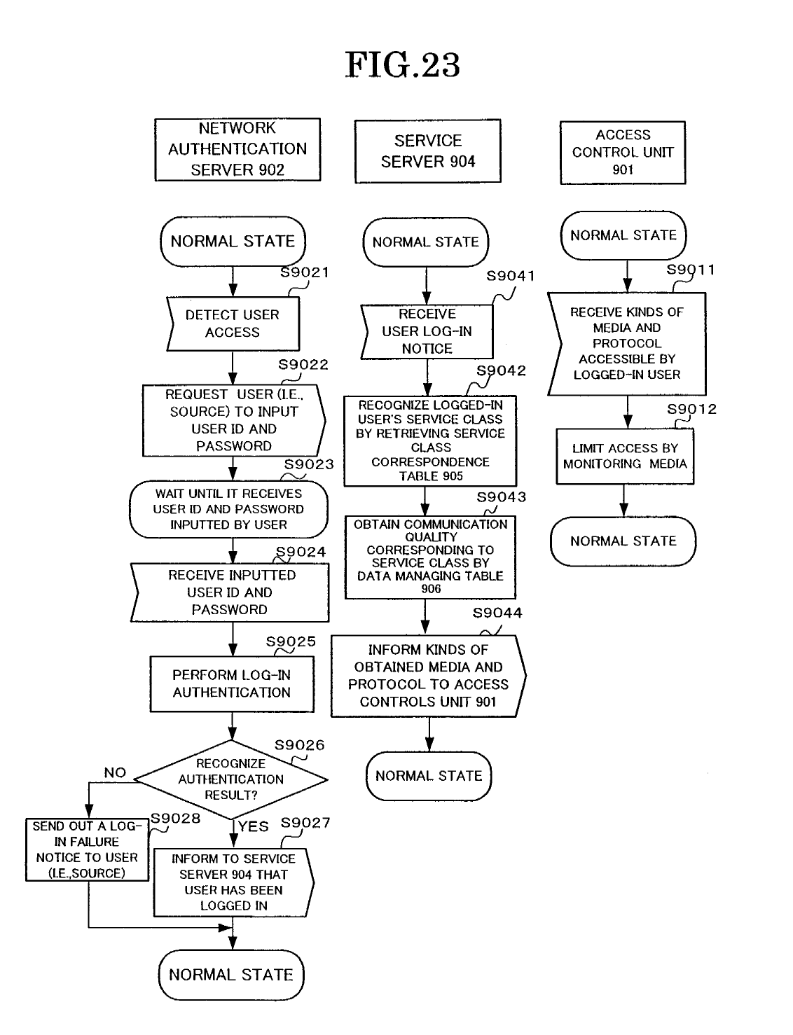

FIG. 23 is a flow chart showing the operation of the entire system of the FIG. 22 embodiment. In the Figure, first when the user accesses the public internet connection service system 900, the network authentication server 902 detects the user's accessing (S9021), requests the user to input user ID and password (S9022), and then waits for the reception of user ID and password inputted by the user (S9023) . When the network authentication server 902 receives the inputted user ID and password (S9024), the network authentication server 902 performs log-in authentication by matching the registered user ID and password (S9025). The network authentication server 902 recognizes the result of authentication (S9026). When the network authentication server 902 recognizes identity, it informs to the service server 904 that the user has been logged in (S9027). When the network authentication server 902 fails to recognize identity, it sends out log-in failure notice to the user (i.e., transmission source) (S9028).

When the service server 904 receives user log-in notice (S9041), it recognizes the user's service class by retrieving the service class correspondence table 905 (S9042), obtains accessible media and protocol of the kind corresponding to the recognized service class (S9043), and informs the kinds of the obtained media and protocol to the access controls unit 901 (S9044) . When the access control unit 901 receives the kinds of media and protocol accessible by the logged-in user (S9011), it monitors user's communication messages and limits media sent out to the user and communication protocols utilized by the user (S9012) . Thus, classified services can be provided to the users.

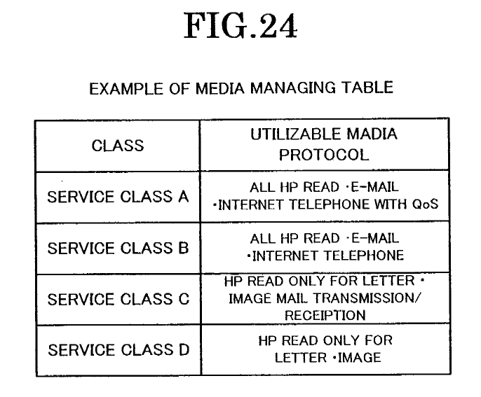

FIG. 24 is a view for exemplifying the status of holding data in the data managing table 906. As shown, internet services which can be utilized are set for the service classes A to D. Users can select service ranks as desired, and are required to pay only fees corresponding to the pertinent service classes.

As has been described, an internet connection services providing method and system according to the invention can provides services versatile, gives the users a right to select services, permits the dealer to increase users by making services versatile and is free from too cumbersome operation and decision by users.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. An internet connection service providing method, comprising:
presetting a service class, among a plurality of service classes, for a user, wherein said service class is selected by the user,
providing an internet connection service in a plurality of places by a particular ISP (internet service provider),
providing user management data concerning said preset service class for said user, and service class correspondence data representing service contents corresponding to said service class,
providing a service, based on the user management data and the service class correspondence data, to said user, irrespective of connection from any one of the plurality of places.

2. An internet connection service system comprising:
a user management database capable of providing internet connection service in a plurality of different places under management by an ISP (internet service provider) and having data concerning a plurality of service classes,
wherein a service class, among the plurality of service classes, is selected by a user and preset for said user, and
a service class correspondence table representing service content corresponding to the plurality of service classes, respectively,
wherein a service being provided to said user, based on the user management database and the service class correspondence table, is irrespective of which of the plurality of places a connection is established from.
